(19) United States
(12) Patent Application Publication
(10) Pub. No.: US 2003/0194071 A1
(43) Pub. Date: Oct. 16, 2003

(54) Information communication apparatus and method

(76) Inventor: Artoun Ramian, Marbella (ES)

Correspondence Address: Artoun Ramian, Playas Del Duque, Casa Cordoba CII No., Marbella, 29696, ES

(21) Appl. No.: 10/222,701

(22) Filed: Aug. 16, 2002

Related U.S. Application Data
(60) Provisional application No. 60/383,891, filed on May 29, 2002.
(60) Provisional application No. 60/372,670, filed on Apr. 15, 2002.

(51) Int. Cl. H04M 15/00

(52) U.S. Cl. 379/114.19; 379/114.01

(57) ABSTRACT

A telephony system that enables a user to personally his/her telephone number or numbers that can reach a particular handset and then change those numbers at will, or block certain parties from reach the handset. The handset also features a swipe slot so that a credit card can be inserted therein. A method of using a unique one time use credit card that is useless of a thief provides security to prevent fraudulent charges by non-authorized users.

### BACKGROUND OF INVENTION

1. Field of the Invention

The present invention generally relates to a communication system, enabling a user to effectively prevent unsolicited contact from any uninvited third party, defined as at least one other person or device with which the invention has an ongoing call in progress and a credit card authenticating system, enabling a user to have substantially enhanced control over the credit card authorization process to prevent an unauthorized third party from using the credit card and to effectively remove the burden of chargebacks to the credit card merchant for unauthorized third party use.

2. Description of the Related Art

To date telephony systems have presented their users with rigid frameworks, within which they have a basic set of features related to placing and managing calls.

Central to the many shortcomings of current art is the fact that the user has a seemingly unrestricted public persona, in so far as the telephone number of the user can be readily transmitted simply by word of mouth, where the friends of the user can pass on the user's telephone number without first seeking permission. Obviously, this defeats the wish of those users who require having an unlisted number. Therefore, if the user feels their telephone number is known by too many unauthorized people then, apparently, the only course of action is to change to a new telephone number. However, with present systems, this incurs financial costs, time and administrative overheads, and the user must ask their service provider to execute the change of number for them, which invariably takes yet more time.

The related ability of having a user to inform a predefined group of third parties of the user's telephone number change or to have a user selectable number for each predefined group is also not found in the prior art.

Virtually all kinds of telephony systems comprise call forwarding, where the user does not wish to receive calls at the user's regular number, opting instead to have the calls redirected to another destination number. An annoying gap left in call forwarding systems is the lack of verification that the destination telephone number is valid, and that the receiver of the call at the destination is willing to accept forwarded calls.

Telephony systems also feature call barring, which typically prevents the user calling certain numbers, yet it allows any third party to call into the user. This is an inherent fault as it leaves the user open to a form of SPAM. SPAM is an annoying practice, where other users exploit electronic communications systems to deliver unsolicited messages, or other forms of information, to the users of the electronic communication systems. Mobile telephones, in particular, pre-pay telephones, are widely available, and may be used to abuse legitimate network users. The anonymity, rightly afforded to any potential user, makes it difficult for users to know exactly who is calling, at least when contact is first established between two users. This anonymity leaves users open to abusive phone calls, the source of which can potentially never be traced. Therefore, present systems art lack an ability to prevent a third party from calling the user, where the user will authorize those third parties that are allowed to call in to the user.

Present mobile cellular telephones are supplied with a hierarchical menu, which allows the user to both configure the handset, and customize the relationship between the handset and the cellular network. Handset is typically defined as any device which can be used to make and receive calls. For example, the GSM system will enable the user to have all calls forwarded to an automated call handling system (ACHS) if the handset is out of signal range of the cellular network. The restriction this places on the user is inherent in the network itself, as oppose to the handset, in so far as all calls will be diverted to ACHS, not just those incoming from a specific third party. Current devices, especially cellular networks are designed to apply rules about call management in a global sense, i.e. they are applied to all calls, as oppose to allowing the user to apply call diversion to specific third parties.

Provisions for enabling the use of a user mode is not disclosed or suggested in the current art. User mode is defined to mean the way in which a user of a telephony system changes between work, leisure or other such activities, throughout the course of a day. Examples of changing user modes are as follows. The user rises in the morning to begin the working day. Then, the user changes to lunch hour activities and returns to work, then perhaps visits a gymnasium. Finally, the user returns home. Each of the user modes would cause a user to wish to handle calls in a different manner. User modes and their related call handling methods would likely change from day to day, or at least from work days to weekend days. The capability of management of the user's calls to reflect the changes in the user's day is not found in the prior art.

Current systems restrict the amount of information a user has about incoming calls. When an incoming call is received by a handset, the user is informed of the calling telephone number. GSM handsets and the like then use this number to search the user's telephone directory, stored in the handset, to lookup the name of the third party who owns the number being provided to the handset by the cellular network. The “lookup” is often referred to as a reverse number lookup (RNL). Present devices lack the ability to use the RNL to find additional information, generally available on the internet and held in publicly accessible telephone directories. The additional information is not presently provided to the user via the handset as an incoming call is received.

Another deficiency in current devices is the inability for a third party to select to speak directly to ACHS. For example, if a third party wishes to tell a user of a telephone number, knowing that the user does not possess a means of noting down the number, the third party should be able to record a message, containing the telephone number, in the user's ACHS.

The use of credit cards has proliferated to the point where the dollar volume of credit card purchases exceed the dollar volume of purchases made using cash or checks. Electronic commerce over the Internet is also experiencing explosive growth. An estimate made a few years ago, suggest that electronic transactions will account for trillions of dollars. These estimates continue to track even higher than expected despite the slowdown in the global economy.

While this phenomenon has helped fuel the unprecedented growth and profitability of the retail trade, the level of fraud using credit cards has similarly grown exponentially. Ensuring that fraudulent use of credit cards is reduced or eliminated, credit card companies, banks, merchants, as well as lawmakers have attempted various methods without much success.

To prevent consumers from burden of payments resulting from fraudulent transactions using their credit cards, the Federal Government, with the respective states, promulgated the Credit Card Liability Act which limited the responsibility of the card owner to a maximum of $50 for unauthorized uses of their credit cards without prior notification to the issuer that the card had been stolen or otherwise was being misused. Further, the burden of proof rests with card issuer to establish that the user had authorized the use of the card and benefited therefrom. Thus, the burden for the loss is transferred to the merchant or the issuer or the issuer's insurer.

If the cardholder denies having entered into a credit card transaction in which pertinent information had been obtained, and the cardholder can establish that there was no benefit to him/her such as delivery of the goods, the card issuer has no legal basis by which the issuer can be assured of payment. The mere use of card information is insufficient to establish that the actual cardholder authorized the transaction. This is due to the fact that a large number of people have access to this information. This information can be viewed as a “public key” which will be discussed below. Faced with unmanageable risks of trying to enforce unenforceable contracts, card issuers have adopted the policy of requiring merchants to assume the risk as a cost of doing business. Thus, if the cardholder repudiates a card transaction for which there is no evidence of delivery of goods to the customer, or voucher signed by the customer, the bank makes a chargeback against the merchant. That is, the card issuer obtains reimbursement from the merchant of the amount paid to the merchant for that transaction as well as administrative fee. While this cost only directly affects the merchants, in reality, everyone must pay the price through higher prices to offset losses or higher insurance premiums as a result of payment by the merchant's insurers for such losses.

In addition, despite the consumer protection laws, it is still entirely possible that a consumer can be responsible for the full amount of the fraudulent purchases or cash withdrawals if the holder of the card fails to notify the issuer of the card in or within 60 days of after the first bank statement was mailed that contained fraudulent charges or cash withdrawals. Thus, when a card holder has a number of supplemental cards, for example, family members or a business card holder where supplemental cards are supplied to a number of employees, it is entirely likely that it will take the card holder far longer than the 60 day period to recognize that a card has been stolen, skimmed (an illegal copy) or used for an embezzlement scheme.

Serving as a means to prevent merchants and issuer from a user fraudulently denying the existence of a contractual relationship pursuant to a transaction, The Federal Government also adopted the Millennium Digital Commerce Act which provides, inter alia, the validity of electronic signatures. This bill was further embellished by the Electronic Signatures in Global and National Commerce Act which created a legal framework for electronic signatures. State legislatures have also adopted similar bills to define and enforce electronic and digital signatures. In New Hampshire, a digital signature is defined as a type of electronic manipulation that transforms a communication using an asymmetric cryptosystem such that a party having the transformed communication can be certain that it is authentic.

The use of a digital signature which cannot be changed once issued from a particular computer protects both buyer and seller in any transaction that occurs via e-commerce. The buyer cannot claim the purchase was not made, because the buyer's data signature cannot be reproduced or sent from anyone else computer. Moreover, the seller cannot alter the contract because the digital signature cannot be changed without destroying the “document”.

There are basically two types of encryption that are in use today. The symmetrical method uses a single key or code that is used by both sender and receiver to encode and decode a communication. A commercial example of this type of method is the Blowfish Encryption Algorithm which was first introduced in 1994. It is available for use without charge. According to Counterpane Internet Security, Inc. of Cupertino, Calif., at least one hundred fifty products using this method are currently available. Other examples are DES, triple-DES and Rijndael which is touted to be the new Advanced Encryption Standard. The inherent weakness in this method is the sender and recipient must have the same single key or code in order to communicate with one another. Therefore, it is possible for someone to intercept the key and then decode the messages.

An asymmetric cryptosystem is a more complex system but inherently more secure. This method uses a private key or code and a public key or code. The public key can only encode communications; it cannot decode it. Your private key stays safe with the user. When a party sends a communication which has been encoded with the public key, the user decodes the communication using his/her private key. A valid digital signature operates on asymmetrical cryptography methods.

The use of encryption keys, especially ones that are long, can provide enormous security. An as example, a 128 bit key provides 3.4 times 2 to the 128th power of possible combinations. A brute force method of trying to break this code will takes days of computer running time.

Firms such as PSIGate provide fraud protection services to decrease the incidence of this crime. Their services include address verification services, valid card number check, spending patterns checks, frequency of card usage and guards against automatic credit card number generation programs.

Yet, despite the existence of this type of encryption security and digital signature technology, credit card fraud is still pervasive. In order to understand why this is so, it is important to follow typical credit card transactions excepting those involving digital signatures.

A cardholder, who wishes to make a purchase, provides his/her card to the merchant who swipes the card through a card reader to read the information stored on the magnetic strip on the back of the card. Currently, most cards have little recording capability, so the magnetic strip provides only a limited amount of information such as account number, expiration date, issuer, password requirements, etc. However, this limited amount of information which often includes PIN numbers is usually sufficient for a thief to violate the system.

The amount of the transaction is entered by the merchant. The card issuer or credit card service such as MasterCard verifies whether the card is valid and whether this current transaction will exceed the credit limit. If a daily transaction balance is exceeded, the transaction will be terminated. In the case of supplemental cards, it is possible for the primary cardholder to limit the daily amount of transactions for supplemental cards. This might be desirable when a parent gives his/her child a credit card for use in college but doesn't want the child to purchase more than a certain amount without a supplemental authorization.

If the card holder has requested that PIN (personal identification number) or code word is to be required to obtain an authorization to conduct the transaction, this will also be indicated. A cash advance or a debit card always requires the use of PIN in order to complete a transaction.

The fact that the use of the PIN is optional with merchants and mandatory with debit cards is a matter of who is responsible in the event of fraudulent use. With debit cards and cash advances, it is the cardholder's financial institution which will experience the loss. In the remaining case, it is the merchant which will undergo the loss.

After the transaction is approved, the merchant is supposed to verify the signature on the card with the signature obtained on the purchase receipt which can be done either by electronic pen or by cardholder signing the transaction receipt to indicate acceptance of the sale.

Many credit card services are also offering their customers the ability to place their photograph on the card to further guarantee that the purchaser is indeed the owner of the credit card that has been presented.

Clearly, the use of a PIN in combination with photograph makes unauthorized purchases or cash advances by someone other than the actual owner of the credit card extremely unlikely.

However, most people do not make use of a full time PIN or have their picture on the card. Further, the quality of checking the signature on the card against the signature provided by the purchaser is haphazard and may not be done at all. Employees of the merchant, watching the cardholder make a purchase can easily obtain the PIN and the remaining information from the transaction receipt.

Further, when the purchase is made over the telephone with purchaser ordering merchandise to be sent to a location other than the card holder's address, the opportunities for fraud are even greater. There is no way to view a photograph on the card even if one were present. As noted above, a PIN can easily be obtained by employee. Further, there are many legitimate reasons for asking that the purchase be shipped to another location such as the purchase is a gift.

Still another prevalent form of credit card fraud is called “skimming”. It usually takes the form of the cardholder turning possession of his/her card to retail or restaurant employee. The employee then swipes the card through an illegal card reader, called a “skimmer” which provides sufficient information from the magnetic stripe to manufacture counterfeit cards. The typical amount of fraudulent charges that can occur before the fact that has card has been skimmed amounts to $2,000.

Yet an even more insidious form of fraud is utilizing a cardholder's information, obtained either through skimming or outright theft of the card and then opening new accounts in the cardholder's name using the cardholder's information. This type of fraud takes even longer to detect and can result in severe damage to the cardholder's credit before the fraud is found out.

Other methods are limited only by man's ingenuity. The list goes on and on. However, at the heart of virtually all such schemes is the fact the card holder's identity has not been authenticated.

While merchants are able to send the information contained on a user's credit card to the issuing financial institution, there is not found in the prior art any device which will enable the user to transmit information contained on the credit card to the merchant. Consequently, a merchant taking an order via telephone has no way to determine whether the user has the card in hand or does not. Most credit card fraud occurs via telephone transaction in which the purchaser has only been able to obtain the numbers of a legitimate card and not the card itself.

Given the large number of mail order transactions which occur in the world today, it would be highly beneficial to merchants to have callers provide physical proof of possession of the related credit card, or other means of electronic payment using a card reading device, such as a MAGNETIC CARD SWIPE or SMART CHIP READER on a user's telephone.

As noted above, the weak link in the credit card system is the card itself. Once a thief is in possession of the card or is possession of a user's readily available information such as birth date, social security number, address, etc., the thief can obtain one or more new cards unknown to the owner by using the owner's identification. Therefore, a credit card method that prevents such fraud would save consumers many billions of dollars a year in losses which must be borne by merchants and credit card companies which merely pass the expenses onto to the consumer.

Therefore, a telephony system and method that meets the call privacy and related security needs coupled with the use of secure electronic payment methods is not found in the prior art. Further, there is not found in the prior art a method of using a credit card that is analogous to an asymmetrical encryption code, that is having a public key (the card and associated information such social security number, license number, account number, expiration of date, etc.) and private key so that the likelihood of unauthorized purchase or cash advance using the cardholder's credit card or the cardholder's identity is virtually nonexistent. A cardless credit card system that operates in conjunction with a mobile phone is also not found in prior art devices.

### SUMMARY OF THE PRESENT INVENTION

It is an aspect of the present invention to provide a user with telephony capabilities to select one or more telephone numbers which can be used to contact the user.

It is another aspect of the present invention to enable the user to change their telephone number at will without involving any technical support, or service provider personnel, in order to effect the change.

It is another aspect of the present invention to publish the user's telephone number to a predefined list of third parties.

It is another aspect of the invention to verify the telephone number to which incoming calls are to be forwarded.

It is another aspect of the invention to invite the receiver of forwarded calls to accept or reject calls, such that they can refuse unauthorized forwarded calls.

It is another aspect of the invention to allow the user to specify call management rules, affecting incoming calls, on a call by call, or calling party by calling party basis, which determines which callers are authorized to speak to the user. These rules may further be applied to calling groups.

It is another aspect of the invention to allow the user to express the user's current user mode, where user modes indicate the user's current personal situation and whether the user can be reached or not.

It is another aspect of the invention to seek additional information related to calling parties utilizing a proprietary server or other third party directories, databases and the like.

It is another aspect of the invention to allow third party callers to communicate directly with the user's ACHS, providing the third party has been authorized by the user to do so.

It is another aspect of the invention to optionally transfer disconnected calls to the user's ACHS.

It is an aspect of the present invention to provide a user with a credit card authenticating system and method wherein the user has the responsibility for determining whether a transaction is authorized in accordance with a preset authority limit and authenticating criteria.

It is another aspect of the present invention to provide a user with a credit card authenticating system and method that utilizes hardware and software well known in the art.

It is still another aspect of the present invention to provide a user with a credit card authenticating system and method that uses the sound of the user's voice as a means to serve as authenticating that the user is indeed the authorized user.

It is another aspect of the present invention to provide a user with a credit card authenticating system and method that provides for separate and distinct preset levels of authorization for any of the cards that the card holder is responsible including each supplemental card that is issued from the card holder's account.

It is another aspect of the present invention to provide a user with a credit card authenticating system and method that shifts the burden of losses from the merchant to the credit card user provided that the invention is used since the invention virtually eliminates the potential for credit card fraud.

It is aspect of the present invention to provide a user with a credit card authenticating system and method that uses criteria unique to each individual such as finger prints, DNA code, retina configuration, voice, signature, ear shape, face shape, etc. as the means by which there is an authentication that the transaction is being conducted by the authorized party and not by someone who has gained access to the card improperly or illegally.

It is still another aspect of the present invention to provide a user with a credit card authenticating system and method that can be used on the internet as well as point of sale transactions.

It is aspect of the present invention to provide a user with a credit card authenticating system and method that uses a card that requires no signature on the card or other identifying marks which makes it easier for a thief to gain illegal access to the user's account. The only number stored on the card is preferably the account number.

Still another aspect of the invention is to provide a method of purchasing via credit available to the purchaser provided by a third party financial institution to a merchant such that the purchaser, merchant and third party financial have a virtual certainty that the person at the point of sale requesting credit is, in fact, the authorized purchaser.

Another aspect of the invention is to provide an authenticating method for a merchant by means of using digital imaging of a likeness of the authorized purchaser than can be easily and quickly verified by the merchant's clerk that the person making the purchase is the actual authorized purchaser.

It is an aspect of the invention to provide a method using digital imaging wherein an authorized purchaser who is being intimidated to make a purchaser can provide recognizable cues to the server that has supplied the digital likeness of the purchaser such that the cues indicating duress are recognizable to server but not by anyone watching the purchaser.

It is an aspect of the invention to provide a method of using digital imaging such that a comparison of unique dimensions of the purchaser's image is compared to a computer stored version to indicate with virtual certainty that the person making the purchase is authentic.

Another aspect of the invention is to provide an automated updating function so that the latest appearance of the purchaser will be downloaded and stored in the server.

It is the final aspect of the present invention to provide financial transaction verification features, such that the invention can verify for the third party that the user is physically in possession of a related credit card or other means of electronic payment.

The invention provides facilities for interacting with third parties to effect call authorization and administration, such as approving calls received from third parties which are then handled by the user. The invention substantially enhances the control of the user's telephone number over that provided by current methods. A plurality of rules can be used to dictate any automated actions to be taken by the system when specified events are detected. The invention further incorporates financial transaction and related security capabilities. The invention is associated with a communication server which further enhances the variety of services provided to the user.

In the preferred embodiment, at least one telephone exchange, in the form of a computer server, and at least one handset is provided. To enable the user to easily learn to use the system, the “look and feel” of a typical mobile telephone is preferably utilized.

The invention gives the user a higher degree of control over accessibility by third parties through call management rules that allow the user to globally deny access to all calling third parties and choosing which third parties are authorized to call when each does so for the first time. Optionally, the invention could be configured to deny access to all calling third parties, placing the details of each in a buffer, which the user can browse at a later date, again, deciding which third parties to authorize.

A principal means of controlling accessibility is provided by the capability of permitting the user to change the user's telephone number at will, and without the intervention of any technical assistant or service provider.

The invention makes significant advances in call forwarding technology, by validating the destination for forwarded calls and optionally asking the destination if it wishes to receive the forwarded calls. The invention uses the notion of user mode to allow the user to express their current situation which will have a direct effect on how they handle calls throughout the day.

The invention makes further advances on CALLER ID displays by using reverse number lookup techniques, in order to enhance the amount of information available to the user about a third party when an incoming call is received.

The invention also allows callers to communicate directly with the user's ACHS even though the user may be available to talk, thus enabling callers to leave informational messages for the user, without the need to interrupt the user. The user will, in advance, authorize those third parties whom are able to utilize this aspect of the invention.

The invention further includes means of interacting with merchants to validate the use of payment cards such as CREDIT CARDS or EFTPOS CARDS, such that the merchant has a higher degree of confidence that the user is in possession of the cards.

Other aspects, features and advantages of the present invention will become obvious from the following detailed description that is given for one embodiment of the present invention while referring to the accompanying drawings.

### BRIEF DESCRIPTION OF THE DRAWINGS

FIG. 1 is a flow chart showing an overview of the invention and its corresponding components.

FIG. 2 illustrates the logic flow executed when a user wishes to change his/her telephone number.

FIG. 2a illustrates the logic flow executed when the user wishes the invention to provide an easy to remember telephone number.

FIG. 3 is diagram showing the sequence of steps to automatically inform the user's “close contacts” of major changes in the user's information.

FIG. 4 depicts the logic used for testing that a destination number, which is to receive forwarded calls, is indeed a valid telephone number.

FIG. 5 is a flow chart showing the steps involved to verify that a third party is willing to accept forwarded telephone calls.

FIG. 6 is block diagram showing the logic flow executed when an incoming call arrives at the invention.

FIG. 6a illustrates the selectable user modes.

FIG. 7 depicts the flow of logic for altering the current user mode.

FIG. 8 depicts the logic used to allow third parties to communicate directly with the user's ACHS.

FIG. 8a depicts the logic used to detect disconnected calls in order to forward third parties to ACHS in the event of loss of signal.

FIG. 9 is an illustration of an apparatus used to verify financial transactions.

FIG. 10 is a flow chart showing an overview of the invention and its corresponding components.

FIG. 11 is a flow chart showing a detail analysis of the authenticating decision process in accordance with the invention.

### DETAILED DESCRIPTION OF THE INVENTION

The invention is an information processing apparatus and method having at least one handset, and at least one exchange, where term “exchange” is defined to mean a related system that ensures calls can be made and received by the user, who is in possession the at least one handset. The preferred embodiment is a cellular telephone network although the invention could also be envisaged as a landline telephony system or other similar systems.

The invention places the user in control of selecting which calls are permitted to reach either the ACHS or the user's handset. The features of the invention relate to ACHS, telephone number change under the control of the user and automated call authorization (ACA), and encompassing how the user operates call management.

Telephony systems while fundamentally useful as a communication network do not allow users a great deal of privacy, or control over key aspects over the setup of communication features. Current cellular networks provide handsets which appear to be laden with features. However, such devices are easily viewed as a basic feature expressed in many different ways yet there really isn't a great deal of varied functionality, just a few minor variations of simple services. For example, there are numerous ways to divert calls to ACHS if the handset is outside of range of the cellular network, or if the handset itself is simply switched off, but all such features are just the basic service of diverting calls to ACHS.

ACA enables the invention to decide, based upon rules expressed by the user, whether a third party is permitted to communicate with the user, or ACHS, or not at all.

Due to the fact that the invention enables the user to change their telephone at will, and for any reason, it would appear at first glance that a finite quantity of telephone numbers would be rapidly allocated. An inherent problem with reallocating numbers which were previously owned by other users is that nuisance calls received by the original user would be targeted at the new owner of the number. In that only authorized callers may communicate with the user, nuisance callers are not on the call authorization list. Therefore, nuisance calls may only be received from authorized callers, who can easily be removed from the call authorization list. Thus, the original owner of the number should not receive too many nuisance calls and that the new owner of the number will receive zero nuisance calls, as the nuisance caller is not on the authorization list of the new owner of the number.

The invention enables the user to publish number changes to a predefined list of third parties. If the user does have to change his/her number, and then close third parties, for example employers or family members will be automatically notified of the number change.

The invention promotes the authorization of calls as much as possible to protect the privacy of those involved in making and receiving calls. This feature is highly valuable when considering forwarded calls. When a user instructs their telephony provider to divert calls coming to their handset, to a different location, it is entirely possible that an input error could occur. This could mean that the user forwards calls to an incorrect destination.

Nuisance calls can also be caused by incorrect or even intentional call forwarding setups. Cases have been noted where calls to businesses have been diverted to private telephone users, causing a large influx of diverted calls to arrive at the handset of the private user. Therefore, the invention provides means of verifying the numbers to which calls are forwarded, and further, if the destination number is a user of the invention, invites the destination to authorize the forwarded calls. This saves time for the destination user, as one authorization will optionally allow all forwarded calls to come in, therefore the user will not have to authorize each incoming third party call.

A modern communication system, particularly a telephony system, is at first glance, a simple device that enables a user to make and receive calls. However, as the user begins to accrue a larger number of third party contacts they begin to feel the need for a means of automatically handling calls. A basic form of automatically handling calls is a voice mail system. Typically, the voice mail system will receive calls when the user is unavailable, but the user can be unavailable for a number of reasons, and each reason may warrant a different behavior with respect to automatic call handling.

The invention provides a means of enabling the user to express his/her current user mode. Each user mode describes a period of time based on the twenty-four hour clock, plus optional specification of days of the week and/or calendar dates. User modes can be invoked on an ad hoc basis, meaning the user expresses to the invention that a specific mode has been entered. For example, a user mode, such as “at work” can be described as being a period of time between 9 am and 5 pm, where the user wishes for the invention to forward all incoming calls to the ACHS. A further user mode, such as “at home”, described as a period of time from 5 pm to 9 am, i.e. covering all the time when the user is not in the “at work” mode, can be used when the user wishes to manually handle all incoming calls. The “at work” or “at home” user modes can be invoked at will anytime the user wishes to have all calls handled in the related manner, regardless of whether or not the user is really at home or at work.

Invoking a user mode causes a related set of rules to come into operation. Set of rules means a collection of instructions which dictates how the invention handles each individual incoming call. An example of a rule may be when the telephone number 1234567 calls the invention; the call is automatically forwarded to the ACHS. This example illustrates that all other calls, except those from the number 1234567 will be allowed to come straight the handset, comprised by the invention, where as those from the number 1234567 will go to the ACHS and the user will later be notified of a new message being received.

Current systems allow handsets to hold a telephone directory containing names and telephone numbers of third parties with whom the user has become acquainted, referred to as directory entries. The prior art has also reached the point where directory entries can be grouped together under headings such as friends, or work contacts, such grouping being referred to as a call group.

The invention allows the user to apply a user mode to at least one directory entry or at least one call group.

The invention allows the user to specify that when new numbers are calling into the handset, i.e. they have not been authorized to call in, that the call be allowed the first time so the user can decide whether to accept future calls, or the call can be placed in an authorization buffer, where callers are browsed by the user and processed one by one.

When new numbers are encountered the invention can use RNL to seek information from the internet to increase the quality of information provided to the user about a third party. This information is typically available from sources such as YELLOW PAGES, WHITE PAGES, ONLINE DIRECTORY ENQUIRIES and the like.

When a user is available to accept calls, the ACHS is disabled in present systems. This means that callers that wish only to leave an informational message for the user have no option but to speak to the user. The invention provides a means of allowing callers to opt to speak directly to the user's ACHS, for the purposes of leaving messages which the user may need to refer back to on a number of occasions. The user is in control of all such aspects, so only those callers who are authorized to speak directly to ACHS may do so. Furthermore, in any case, only those third parties who are authorized to leave messages on ACHS are allowed to do so, to prevent the user's ACHS from becoming flooded with SPAM.

Given the large number of mail order transactions which occur in the modern market place it seems that fraudulent use of payment cards is constantly on the increase. However, studies show that fraudulent use occurs more frequently when physical possession of the payment card is not required. For example, when paying for gasoline at a service station, the customer is required to present a payment card, which is then swiped and verified by the related bank. However, internet purchases and purchases over the telephone require no proof of physical possession, i.e. the user does not need to be holding the card at the time of purchase. This lax method of collecting payment leads to an increase in fraud of an order of magnitude. Having a means of reading a payment card, coupled with a communication device such as a telephone or mobile telephone would enable a merchant to request that the user reads the card, which must be in their possession. The telephone or mobile telephone would then electronically forward the details to the merchant, aiding in the alleviation of fraudulent payment card use.

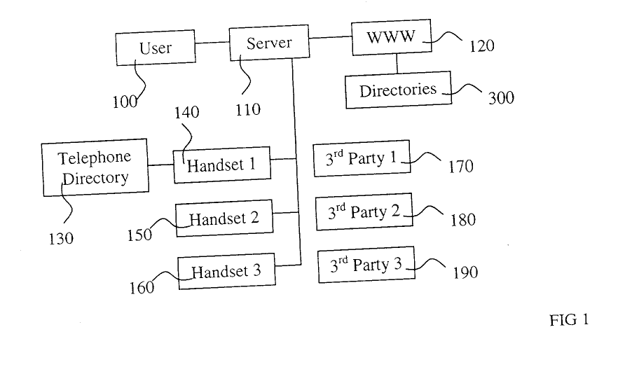

FIG. 1 is an illustrative overview of the invention with related handsets, communications equipment and third parties which will interact with the user during calls.

User 100 is in possession of handset 140, which can selected from but not restricted to a GSM MOBILE PHONE as manufactured by MOTOROLA or SAMSUNG. Handset 140 is used to communicate with server 110 which manages incoming and outgoing calls between user 100 and third parties such as third party 170, third party 180 and third party 190.

Handset 140 communicates with server 110 using a digital communication protocol provided for by the GSM STANDARD. The protocol allows for the transmission of voice or data, where data can be that which is normally provided for by a modem, as in packet data, or can be text messages sent and received by user 100, which are subsequently encoded/decoded for transmission and reception. The GSM STANDARD is adapted for carrying voice information. The emerging GPRS system could similarly be used as this also provides for an “always on” scenario where user 100 is always connected to WWW 120 and can simultaneously make and receive voice calls.

In order to provide additional information about calling third parties, server 110 will utilize the World Wide Web (WWW) 120; to enhance the amount of information user 100 has about any of the third parties when they call into the invention.

Current systems send only the telephone number of the calling party to handset 140 whereas server 110 enhances the information by providing information such as name, address, descriptions of services offered by the caller, all retrieved from services which are resident within WWW 120. Information provided by server 110 can also be stored in directory 130, a local telephone book contained in handset 140, which can be utilized by user 100 to place calls or to share information with other users of the invention. The enhanced information can be retrieved from directories 300 which include such services as YELLOW PAGES, WHITE PAGES and other databases providing information about individuals or businesses. Directories 300 can reside within WWW 120 or server 110.

With the GSM system, each of handset 140, and other handsets which include handset 150 and handset 160, further includes a SIM CARD, which has a globally unique identification (GUID) number contained within. Regardless of the telephone number assigned to each handset, the SIM card will always retain the same GUID throughout its life. Therefore, the user is able in present systems to request that their service provider change their number while retaining the same SIM CARD.

The invention improves upon this idea by allowing the user to request a number change simply by exchanging a sequence of messages with server 110. The sequence of messages, or any other sequence of messages between user 100 and server 110, can be enabled by using the SHORT MESSAGE SERVICE (SMS) text messaging protocol, as is provided by the GSM standard. A “message” is defined as a single instance of a communication between user 100 and server 110.

FIG. 1 depicts three potential callers consisting of third party 170, third party 180 and third party 190. The potential callers are all unauthorized in the invention's initialized state. In the initialized state, no incoming calls will be answered by the invention until the user provides confirmation that calls will be received from the third party who is presently calling.

When one of potential caller's contacts user 100, by calling the user's designated telephone number, handset 140 informs user 100 of the incoming call, and tells user 100 that the caller is not authorized. The following diagrams describe the process of authorization or barring the incoming caller from making further calls to user 100.

Telephone directory 130, held in handset 140, or in an alternate embodiment, on server 110, contains the details of all callers who are authorized or barred.

“Barred” means that user 100 will not be informed of any calls arriving from a third party whose authorization was previously refused. Instead, a log is kept which user 100 may view periodically, in order to see who is calling frequently. Constructing and maintaining log files is well known in the art.

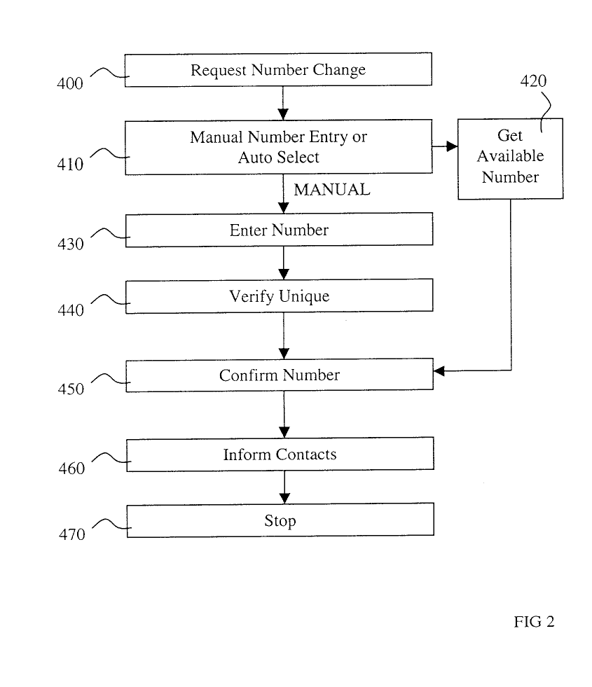

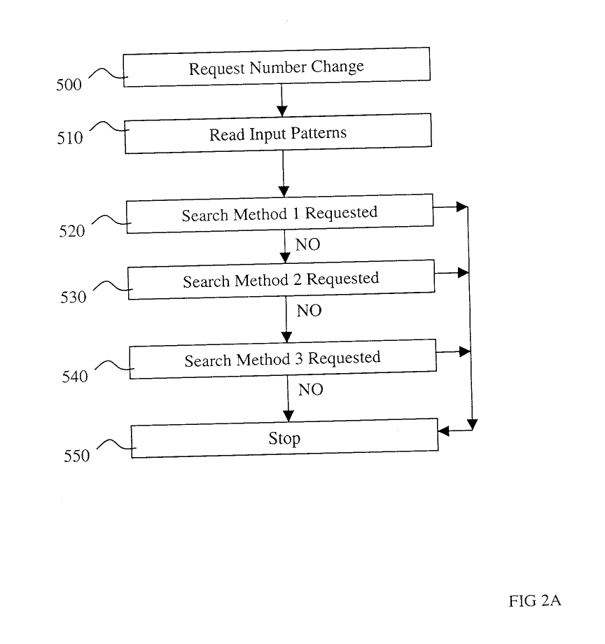

As shown in FIG. 2, the logic flow for changing the telephone number of user 100, solely under the control of user 100, is illustrated.

Beginning with step 400, user 100 sends a message to server 110 informing server 110 of the wish to have a new telephone number.

At step 410, the user can enter a telephone number of his/her choice or have server 110 assign the next available telephone number. The preferred method of the invention is that server 110 automatically selects the new telephone number, as this saves the user having to constantly re-key telephone numbers every time a number that is in use is selected. However, an alternative would be to use alphanumeric information as a “telephone number” which can ensure that most selected numbers would be unique. For example, a three letter code for the particular server, followed by a three letter code for the user, then a typical seven digit telephone number should eliminate most re-keying difficulties. Another alternative would be to have six letters of the user's name as the prefix which would probably be easier for third parties to remember. For example, RAMIAN 555-1234, RAMIAN 555-1235, RAMIAN 555-1236, etc. The number of telephone numbers corresponding to the user's SIM is limited only by the capacity of server 110 and the universe of unique “telephone numbers”.

If user 100 chooses to manually select their own new telephone number, then flow moves to step 420 where user 100 enters the new telephone number that they have thought of. At step 440 server 110 searches its internal directory of telephone numbers and ensures that the number entered by user 100 is unique.

If user 100 selects to have server 110 choose the next available telephone number then flow moves from step 410 to step 430, where server 110 reads the next available telephone number from its related database entry and temporarily allocates the number to user 100, until such times as user 100 accepts the change number which is decided at step 450.

At step 450, the user will confirm acceptance of the new number, and if the user is content with the new telephone number, flow moves to step 460 where the invention scans close contacts informing each number in the close contacts that the user now has a new number. If the user is not content with the new telephone number, then flow can restart at step 410 where the user can enter a new telephone number or once again request a number to be selected by server 110.

“Close contacts” is a list of third parties who user 100 considers worthy of automatically being informed of special events. The special events include such changes in state as user 100 changing the telephone number. When a special event occurs, server 110 will undertake to reduce the burden on user 100 by bulk messaging all third parties in the close contacts, such that each third party in the close contacts receives a message providing important information.

The database commands, necessary to enable the flow of logic depicted in FIG. 2 can be translated into SQL statements as supported by MICROSOFT SQL SERVER or ORACLE, both of which are scalable relational database systems, suitable for data storage and retrieval on a massive scale, as may be required for the invention when used simultaneously by a plurality of users 100.

Step 410 will require one SMS message to be sent by user 100 to server 110, detailing the request for the number change. For example, the text of the SMS message could be expressed in English like so, “CHANGE NUMBER TO 555 1234 5678”, server 110, when receiving this message, will then enact the request and change the telephone number of user 100 to that detailed in the message. Prior to enacting the change of number, server 110 will send a further SMS message to user 100, for example, “CONFIRM CHANGE OF NUMBER TO 555 1234 5678”. If user 100 does not reply to the message sent by server 110 within, say, ten minutes, then server 110 will abandon the change of number transaction and user 100 will receive a further SMS message, for example, “CHANGE OF NUMBER ABORTED”.

If user 100 were to send the change of number message formatted thus, “CHANGE NUMBER AUTO”, then this would inform server 110 that user 100 wishes the invention to automatically generate a new telephone number. The confirmation message would follow as previously detailed.

Referring to FIG. 2a which depicts the logic flow used to find an easy to remember telephone number as requested by user 100.

If the invention were to assign numbers in numerical order, for example beginning with the number 1111111 and assigning numbers sequentially, i.e. 1111112 followed by 1111113 etc, then users would find themselves being assigned telephone numbers which were not easy to remember.

It is not possible to ensure all users have an easy to remember telephone number, especially where telephone numbers are automatically assigned to users. However, many pattern algorithms which create repetition within a number are possible and a few are demonstrated in the preferred embodiment. By encouraging user interaction within the process of number generation, the invention finds an improved means of providing a telephone number which is desirable to the user.

The preferred embodiment demonstrates three search methods for automatic number generation. Each involves the creation of a number followed by a check to ensure the number is not already in use.

At step 500 the user requests a number change providing two pieces of input. The first is the ideal number, meaning the telephone number they most desire, and the second is the permitted alterations, meaning the ways in which the user will allow the invention to alter the ideal number if it is not available, in order to gain a unique telephone number.

The permitted changes input comprises a template pattern which indicates static digits, where static digits can not be changed by the invention, and flexible digits, which may be altered by the invention, where a resultant telephone number is found to be in use. The template uses “#” characters to depict static digits and “*” digits to depict flexible digits. Therefore, if the user provides a permitted changes input of “##*##” then the invention may only change the third and final digits of the number, digits 1, 2, 4 and 5 will remain as provided by the user.

The ideal number is identical in format to that provided at step 400 (See FIG. 2). For example the user could request the number 660660, and as this is the same three digit number repeated the user would find this easier to remember.

Search method 1 works where the user provides a permitted changes input of “##*##” where the invention would try to use 660660, followed 661661, followed by 662662 etc, until a unique number was discovered or all permutations were exhausted.

Search method 2 requires the use of an additional character, “+”, depicting incremental groups of numbers. Incremental groups are a contiguous segment of a telephone number which are sequentially incremented together. For example, if the number 660111 was requested with a permitted changes input of “###+++”, then the invention would take the last three digits to be a number in its own right and increment it as such. Therefore the number 660111, followed by 660112, followed by 660113, potentially through to 660999, would all be tried as possible numbers.

Search method 3 is the more abstract and utilizes an alphabetic string to represent digits of the number. The permitted changes input changes radically in this instance.

If the permitted changes input contain alphabetical characters then the invention knows at step 510 that search method 3 is in force.

Each occurrence of an alphabetic character is substituted for a numerical digit, and each occurrence of the said alphabetical character will be substituted with the same numerical digit.

For example, if a permitted changes input of “ABCABC” was provided then the first “A” could be substituted for any digit 0-9, and if in this example the digit was “4” then all occurrences of the character “A” would be substituted for the numerical digit “4”.

More exotic numbers can be created via this method which are not as easy to remember as previous search methods, but this method does potentially provide the user with greater control over the number being provided. Any numerical digits provided in the permitted changes input will be preserved in the output. This means that if the user provides a permitted changes input of “660AAB”, then the output number must begin with “660” followed by automatically generated numbers.

It is recognized that the time to create numbers and search a database to ensure each number is unique can be a time consuming process for a computer system. Therefore the preferred embodiment offers a store of desirable numbers. Said store of desirable numbers can be created by the system administrator, and it is likely that there will be multiple stores of desirable numbers. Each store of desirable numbers would represent possible matches against potential values for the permitted changes input.

In this instance the system administrator would utilize system idle time to create batches of desirable numbers, for use with permitted changes inputs similar to “##*##”. In this example the system administrator would be creating all permutations of numbers similar to “660660”, where “770770” and “880880” would all be stored in the store of desirable numbers related to the said permitted changes input of “##*##”.

As each number was allocated to a user the invention would remove it from the store of desirable numbers, ensuring it can not be issued again, and improving search speeds on future search method invocations.

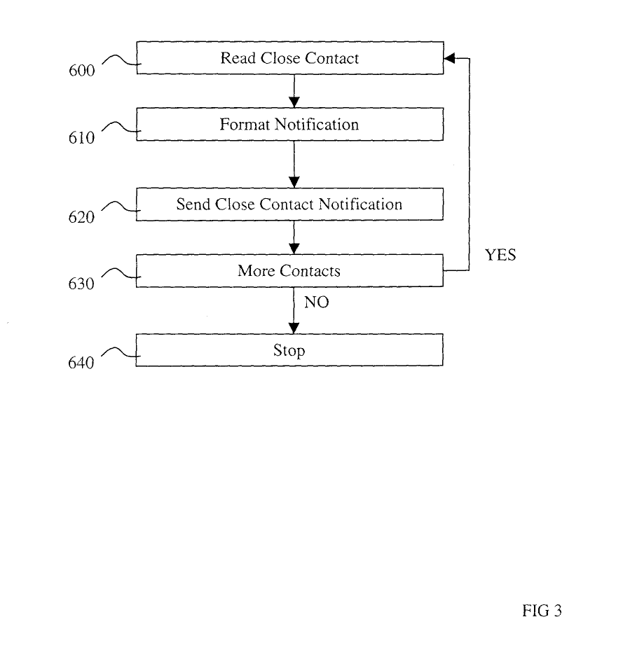

Referring to FIG. 3, the logic in step 430 is described in detail. User 100 is likely to invoke several major changes to their communication settings during their use of the invention. One such the major change is the change of telephone number. The close contacts are formed by user 100 to provide a list of third parties that user 100 wishes to be automatically informed whenever such the major changes occur. Having changed the telephone number, user 100 would have to find a means of informing important third parties of their new telephone number. If user 100 did not inform the important third parties of the new number, then they would all have to be authorized once again so that they could communicate with user 100. This represents a significant burden on user 100.

Therefore, user 100 can create a list of third parties, referred to as the close contacts; in the same way that user 100 can create a telephone directory in the handset. Close contacts for each user 100 are held on server 110, such that server 110 can conveniently access each close contact described by user 100 and automatically send an SMS message to each third party in the close contacts, informing them of important information regarding user 100.

Step 600 is the point where server 110 opens the list of the close contacts. If there are any entries in the list, then the first one is read upon the first execution of step 600. Subsequent executions of step 600 reached by flow returning from step 630 will read the next entry in the close contacts and so on until all close contacts have been sequentially processed.

At step 610, server 110 formulates an SMS message for transmission to each entry in the close contacts, which could be formatted thus, “USER RAMIAN HAS CHANGED NUMBERS TO 555 1234 5678”.

At step 620, the SMS message formatted at step 610 is transmitted in the same manner as the GSM protocol provided in present systems. At step 630, the next entry in the close contacts is read, if end of file is detected, i.e. there are no further entries in the close contacts, then flow ends at step 640, else flow returns to step 600 where the next entry in the close contacts is processed.

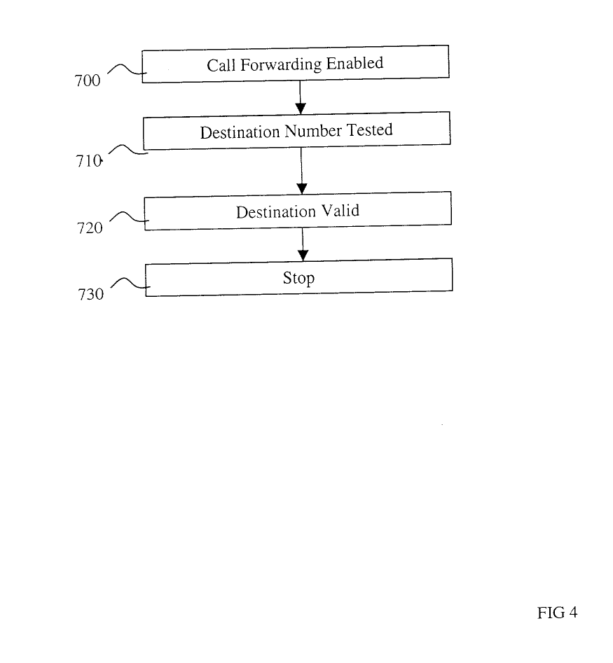

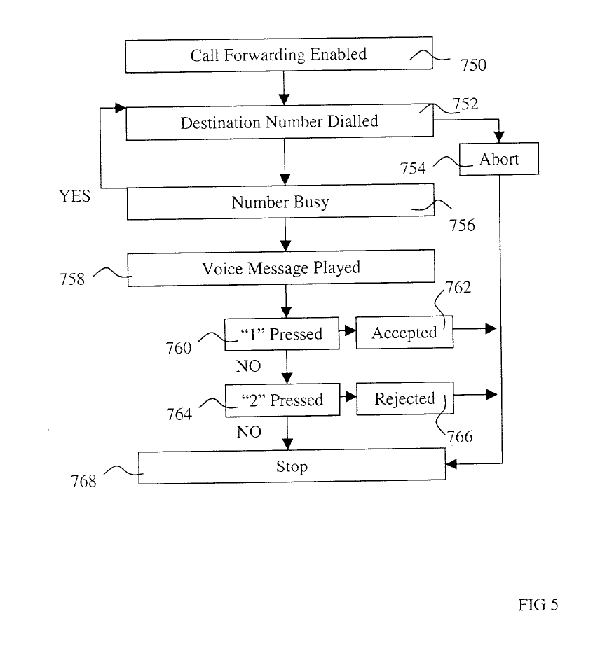

As shown in FIG. 4, the verification of the destination number for forwarded calls is provided. Each time a call forwarding action is requested by user 100, the invention will optionally verify that the destination number is valid. This can simply be enabled by dialing the destination number and if a ring or busy tone is detected, as oppose to a number unavailable tone, then the destination number is deemed to be valid. Other means of validating the destination number are recognized, such as utilizing a telephone directory, which may or may not contain the destination number.

At step 700, the user initiates call forwarding. Call forwarding includes, but is not restricted to, forwarding calls when user 100 is out of contact range of the GSM network, forwarding calls when user 100 has switched off the handset, forwarding calls of specific third parties who call user 100 and the like.

When call forwarding is initiated, then user 100 must provide a destination number to receive forwarded calls. This number is contacted at step 710. If the number is found to be valid then call forwarding is enabled and flow ends at step 730. If the destination number is found to be invalid then call forwarding is not enabled and flow returns to step 700 where user 100 can retry.

Moving onwards to FIG. 5 which depict the logic required to verify that the receiver of forwarded calls is willing to accept the forwarded calls.

At step 750, user 100 initiates call forwarding providing a destination number. At step 752, server 110 dials the destination number. If a busy tone is detected at step 756, then server 110 will loop back to step 752 several times to retry the dial operation. If after several attempts the number is still busy or is unavailable for some other reason, then the invention will move to step 754 where the call forwarding operation is aborted and flow ends at step 768.

If the destination number is answered by a third party, then a voice message, or other form of communication, is transmitted at step 758. The third party can indicate their acceptance of forwarded calls by playing a DTMF tone “1” at step 760 which causes flow to move to step 762, where user 100 is informed that the forwarded calls will be processed by the destination and flow ends at step 768. If the third party plays a DTMF tone “2” at step 764, then flow moves to step 766 where user 100 is informed that the third party will not accept forwarded calls. User 100 is then expected to find another means of handling forwarded calls, possibly by choosing a different destination.

The DTMF tone “1” and the DTMF tone “2” are used merely as an exemplary means of a third party responding to communication from server 110 under any circumstances. Automated voice response systems, known in the art, are common place and use DTMF tones to enable user 100 to navigate a set of menus which will route their call to an appropriate destination. Other means, such as voice recognition are possible and would fulfill steps 760 and 764 if the words “YES” or “NO” are spoken, for example.

The voice message can be recorded by user 100 in the same manner as user 100 can record a voice greeting to be used in conjunction with ACHS. The voice message can also be replaced by other means of communication such as SMS, where a message is formatted and sent to the destination, who can then reply by SMS indicating that they accept or reject forwarded calls from user 100.

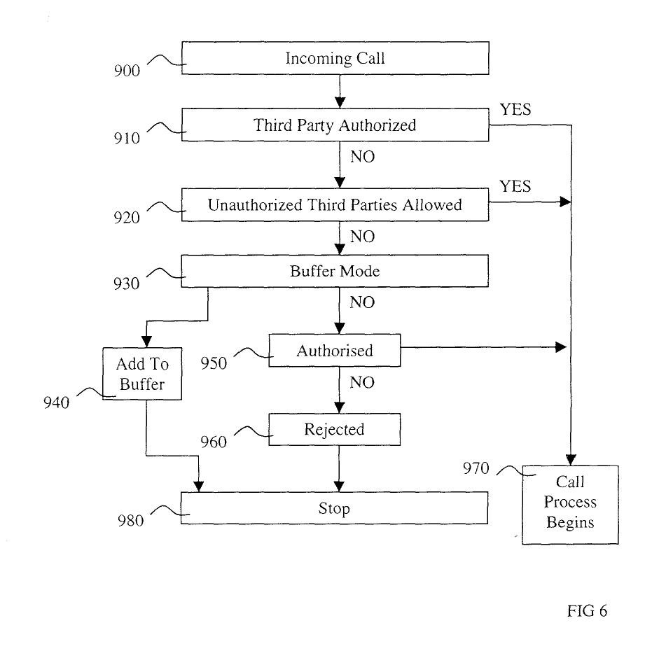

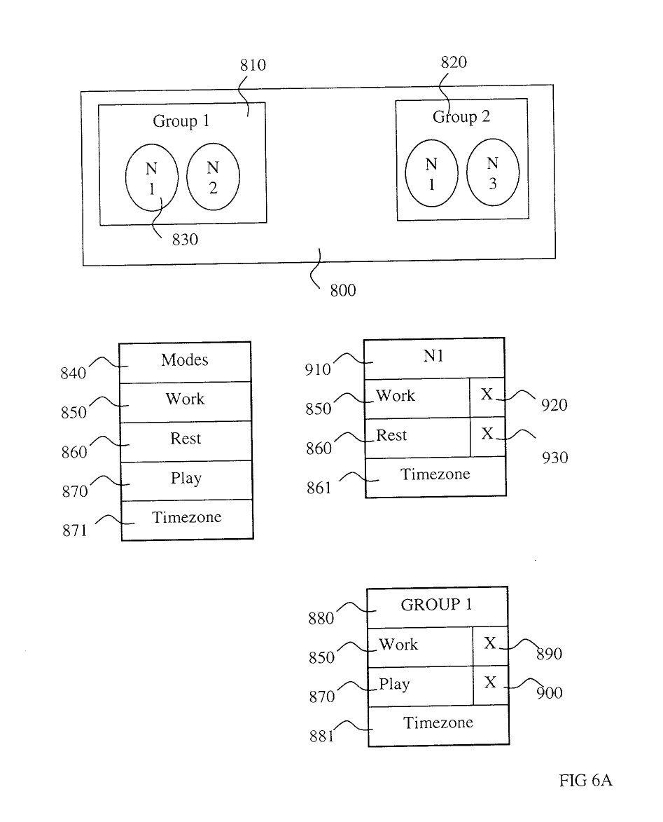

FIG. 6 illustrates the options that user 100 has for processing incoming calls. When the handset detects an incoming call, it must first search an internal authorization list. The internal authorization list is a collection of numbers of third parties who are authorized to communicate with user 100. The incoming call is not restricted to voice communication; it further includes, but is not restricted to, any form of communication such as SMS or data calls, therefore user 100 can prevent unsolicited SMS messages and the like, from having to be processed by user 100.

At step 900, The GSM network will, where possible, provide the handset with the CALLER ID of the third party who is attempting to contact user 100.

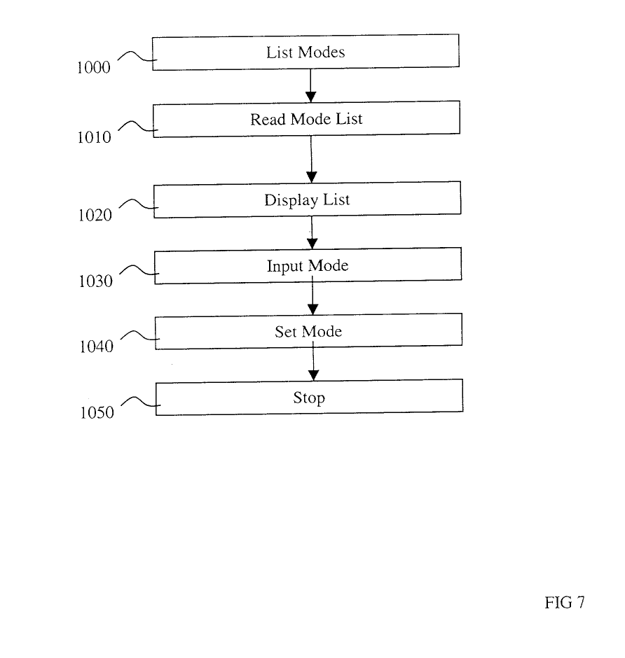

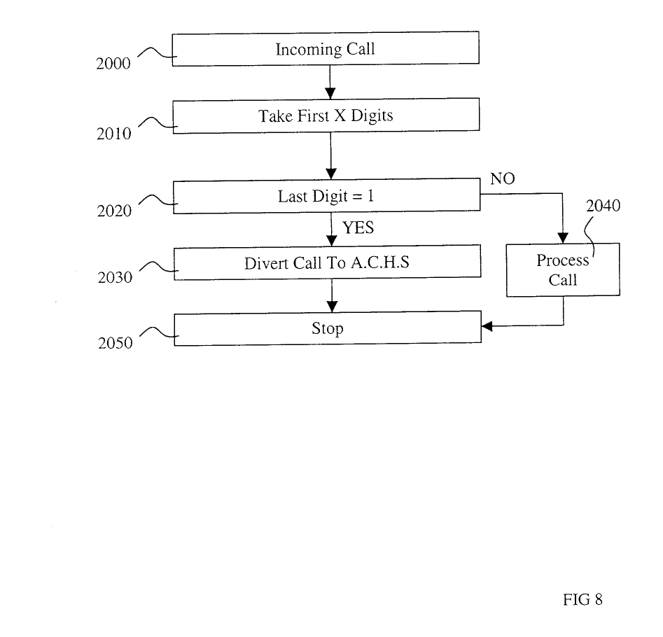

At step 910 the handset uses the CALLER ID as a database key to search the authorization list. If the CALLER ID is not found in the authorization list, then the third party attempting to contact user 100 is deemed to be an unauthorized third party (UTP). If the third party is found to be authorized, i.e. in the authorization list, then the call is processed at step 970. Step 970, which includes call processing logic as further described in FIG. 7.

If the third party is deemed to be an UTP, then flow moves to step 920 where user 100 may have all unauthorized calls allowed. This action would bring the invention into line with current devices, which allows all calls in to the handset, whether or not user 100 desires calls from certain third parties. If user 100 has allowed all UTP's to call, then flow moves to step 970 where the call is processed.

UTP's can be processed in one of two ways. First, they can be added to a buffer and second, they can be processed as the call occurs. At step 930, if buffer mode is in force, then all unauthorized calls are logged at step 940, where the details of the call are recorded for later inspection by user 100, flow finally ending at step 980. If buffer mode is not in force, then flow moves from step 930 to step 950, where the user is required to provide manual authorization for the incoming call, i.e. user 100 indicates that they are willing to accept the incoming call. If the incoming call is accepted flow once again moves to step 970. If the call is rejected, then, at step 960, the CALLED ID of the third party making the incoming call is added to a list of barred callers, making the third party a barred third party (BTP) and no further calls will be accepted from the BTP. All BTP's are held in a further log file which is searched when each incoming call is detected.

Returning to step 920, it is recognized that user 100 will optionally authorize all further calls from the incoming third party, or may choose to accept only the current call. If user 100 chooses to accept all future calls from the incoming third party, then the incoming third party is deemed to be an authorized third party (ATP), and as such is added to a further log containing CALLER ID's of all ATP's.

If a calling third party is neither an ATP nor BTP then the invention will require the user to manually authorize or reject the incoming call.

The logic depicted in FIG. 6 and later in FIG. 6a, as described in the preferred embodiment, will execute within the handset. Alternatively, if server 110 is constructed in such a way that it holds all telephone directories, and all aforementioned logs and lists for all users is similarly placed on server 110, then the logic depicted in FIG. 6 can be resident on server 110. This simplifies the construction of handsets for use in conjunction with the invention. It further simplifies the maintenance of the handset if changes to the logic described in FIGS. 6 and 6a, were ever to occur, in so far as only server 110 would require to be updated, as oppose to a vast plurality of handsets.

Referring to FIG. 6a, simple representations of a telephone directory, available user modes and available call authorizations are shown.

Block 800 represents the telephone directory held in the handset or on server 110. The directory holds contact details of third parties exemplified by N1 830. N1 830 is a single entry in directory 800. Block 810 and block 820 represent call groups. Call group 810 includes N1 830, N2 and N3. Call group 810 could be represented in life as some category such as friends, or workmates. Call group 820 is a further category of third parties. Both call group 810 and call group 820 are included within directory 800. This method of holding numbers and call groups is known in the art. However, the ability of each call group have its own “telephone number” to reach the user's phone is unique. The invention uses directory 800 as a means of identifying individual third parties who are authorized to call user 100.

Modes 840, which includes work 850, rest 860 and play 870 are used to represent phases of the day entered into by user 100.

Work 850 is a mode entered into by user 100 during business hours. Rest 860 is a mode entered into by user 100 during resting hours. Play 870 is a mode entered into by user 100 when entering into any leisure activities.

All time zones, i.e. time zone 861, time zone 871 and time zone 881 are identical in so far as they comprise at least a start time and end time. However, their impact on their related information differs slightly.

Time zone 861 and time zone 871 govern when incoming calls will be accepted from an ATP. For example, time zone 861 governs when N1 910 is allowed to call user 100. If time zone 861 is not completed by user 100 then the invention will allow N1 910 to call at any time, as long as N1 910 remains in the state of being an ATP. If user 100 provides details for time zone 861 then the invention will inspect the start and end times contained in the time zone and if the current time of day, at which the call is received, falls outside of the details comprised in time zone 861, then the call will be rejected.

Time zone 881 behaves in an identical manner to time zone 861, except the impact of time control relates to authorization block 880, which governs when GROUP1 may call user 100.

Time zone 871 comprises details of the time of day during which a given mode can become automatically activated by the invention. If Time zone 871 is not provided by user 100 for a given mode, then the mode must be manually invoked by user 100.

The invention will prevent user 100 from entering time zone details for time zone 871, which would effectively create an overlapping time period with a time zone for an existing mode.

Authorization 910 details under which conditions N1 830, being a potential calling third party, can contact user 100. Block 910 illustrates that N1 830 may call when user 100 is in the following modes, work 850 as indicator 920 shows and rest 860 which indicator 930 shows, and N1 910 may not call when user 100 is in any other mode.

Authorization block 880 illustrates that any third party in calling group 810, being named GROUP1, may contact user 100 when user 100 is in mode work 850 as shown by indicator 890 and play 870 as shown by indicator 900.

It can be seen that N1 830 has specific calling rules as depicted in block 910 which will override the generic rules depicted for calling group GROUP1 810, whose rules are illustrated in block 880, as N1 is comprised by calling group 810, and the invention deems that rules for specific third parties will override any which are imposed upon calling groups of which the third parties may be a member.

The preferred embodiment depicts user 100 maintaining lists of authorized and barred third parties via the handset, and more specifically the telephone keypad and display of the handset.

An alternative embodiment could be formed to use the WORLD WIDE WEB, via at least one web page which allowed user 100 to administrate their lists of authorized and barred third parties. Server 110 would then communicate any changes made to the said authorized and barred third parties via SMS or other protocol such as WAP. This would liberate user 100 from the confines of a standard sized handset, making provision for the display of more call management information than can be presented on a standard handset. Should an alternate embodiment be formed where all lists of third parties are stored on server 100, as oppose to in a handset, then the web page extension to the preferred embodiment would be a highly efficient means of administrating the call management features of the invention. Web pages would be required for the addition and removal of third parties from both the authorized and barred third party lists. Furthermore the web page approach can be used for the creation and maintenance of mode information, governing when authorized third parties can call.

Moving on to FIG. 7 which depict the flow of logic for allowing user 100 to select and activate a specific mode.

It will be recognized by one ordinarily skilled in the art that reading information from databases and displaying the information, such that a user may make a selection from options provided by the information, is a common task for any computer programmer and is well within ordinary skill of the programming art.

The sub routine for listing modes begins at step 1000.

At step 1010, all modes which the user has described to the invention are read.

At step 1020, the list of modes is displayed to user 100 and at step 1030 user 100 is required to make a selection from among the modes.

At step 1040, the invention implements the selected modes and all subsequent incoming calls will be handled according to the rules of the new activated mode.

At step 1050, the flow of logic ends for implementing a selected mode.

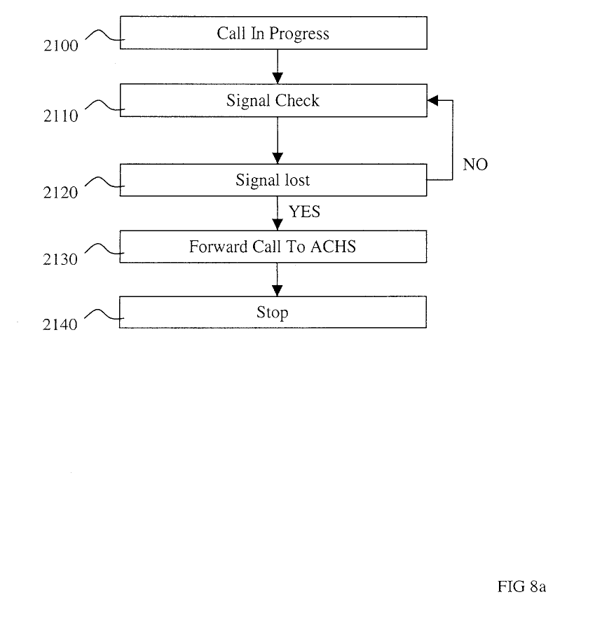

Referring to FIG. 8, the logic that allows third parties to contact the ACHS of user 100 directly is shown.

Telephone networks, known in the art, will typically allow its users to type any additional digits after a valid telephone number, and the additional digits will be discarded or passed onto to the recipient of the call. For example, if 555 12345678 were a valid number and a user dialed 555 123456789 then the additional digit in this case would be the digit 9. This digit can be passed along to the recipient of the call as the telephone network knows that only digits up to but not including the digit 9 are relevant.

Using this means, the telephone network could allow user 100 to dial a telephone number and place an additional digit on the end of the telephone number to indicate whether they wish to communicate only with the call recipient's ACHS. In this way a caller may opt to leave a voice message or other form of message, without having to speak to the user. As noted above, longer “telephone numbers” are required; however, the use of mnemonics can greatly simply remember the additional alphanumeric information.

At step 2000, the subroutine for processing incoming calls begins.

At step 2010, the invention takes significant digits from the number dialed by the calling third party. The last digit, deemed not significant by the dialing process is then taken at step 2020, if the last digit is not a “1” then flow moves to 2040 where the call is processed.

At step 2030 a digit “1” has been detected and the caller is therefore diverted to ACHS as desired.

At step 2050 flow ends for processing direct calls to ACHS.

Returning to step 2040, where calls are processed, this executes the logic depicted in FIG. 6, in order that only ATP's can communicate with user 100.

FIG. 6a, which depicts information for user modes, can be enhanced by adding a field describing which callers, such as N1 830 (see FIG. 6a) may directly contact user 100. In this way, user 100 can maintain a list of third parties who are allowed to contact ACHS directly.

Referring to FIG. 8a, which depicts the logic flow to detect loss of signal which can optionally cause third parties involved in disconnected calls to be forwarded to ACHS.

The subroutine begins at step 2100 where a call is in progress between user 100 and a third party.

A polling loop is formed at step 2110, which checks for a signal between the handset in use by user 100 and the cellular network of the service provider, and step 2120 which causes flow to move to step 2130 if the signal is lost. If the signal is still present then flow returns from step 2120 to step 2110. At step 2130, which is reached in the event of signal loss, the third party is diverted to ACHS in order that they can leave a message without incurring the time taken to redial user 100 simply to leave a message saying how they can be contacted when user 100 comes back into signal range.

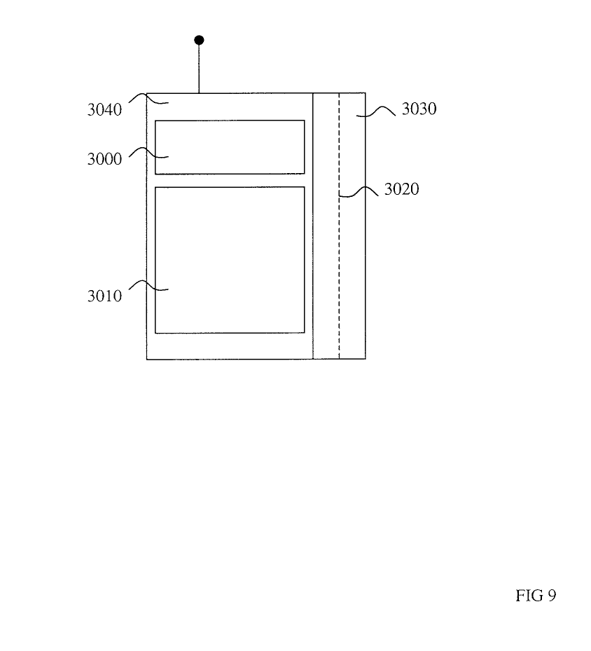

Moving now to FIG. 9, the embodiment of phone 3040, having card technology is shown. The mobile communication equipment is satisfied by the inclusion of handset 3040 which comprises display 3000 and keypad 3010.

FIG. 9 further depicts card reader 3030, which includes slot 3020 through which is passed a credit card, or similar payment card, or any other card having a magnetic strip.

Whenever user 100 contacts a merchant and wishes to pay by credit card, the merchant may require user 100 to prove physical possession of the credit card. User 100 will, in this instance, swipe the credit card through slot 3020, enabling card reader 3030 to read the information from the credit card.

Card reader 3030 will then pass the details, read from said credit card, to phone 3040, in order that the details can be transmitted to the merchant, by utilizing the serial communication interface comprised within handset 3040. In this embodiment, the invention would temporarily be used as a modem for transmitting said credit card details.

The merchant will then have a higher level of certainty that user 100 is in possession of the credit card at the time the transaction is executed.

Some of said credit cards have various forms and nuances. For example, EFTPOS CARDS in some countries require a PIN NUMBER to be entered by user 100, after the EFTPOS CARDS have been swiped. In this case, display 3000 can be utilized to prompt user 100 and keypad 3010 can be utilized by user 100 to provide the PIN NUMBER.

It is recognized that SMART CHIP READERS can be substituted for card reader 3030, depicted as a MAGNETIC CARD SWIPE. It is further recognized that PROXIMITY READERS can also be substituted for card reader 3030, and that the credit card, if so enabled, would merely have to be brought into close proximity of reader 3030, as oppose to user 100 having to insert the credit card into the device depicted in FIG. 9. It is also recognized that phone 3040 could be equipped with forms of wireless communication such as, BLUETOOTH and the like, which enable phone 3040 to communicate with card readers without the need for a cable connection to said card readers. Infra-red communication, referred to as IRDA and the like, can also be used to enable two way communication between phone 3040 and card reader 3030.

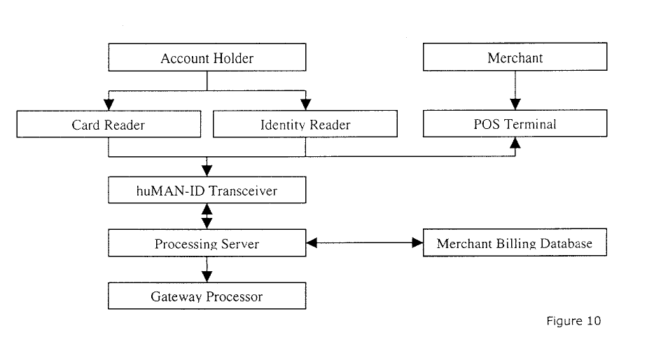

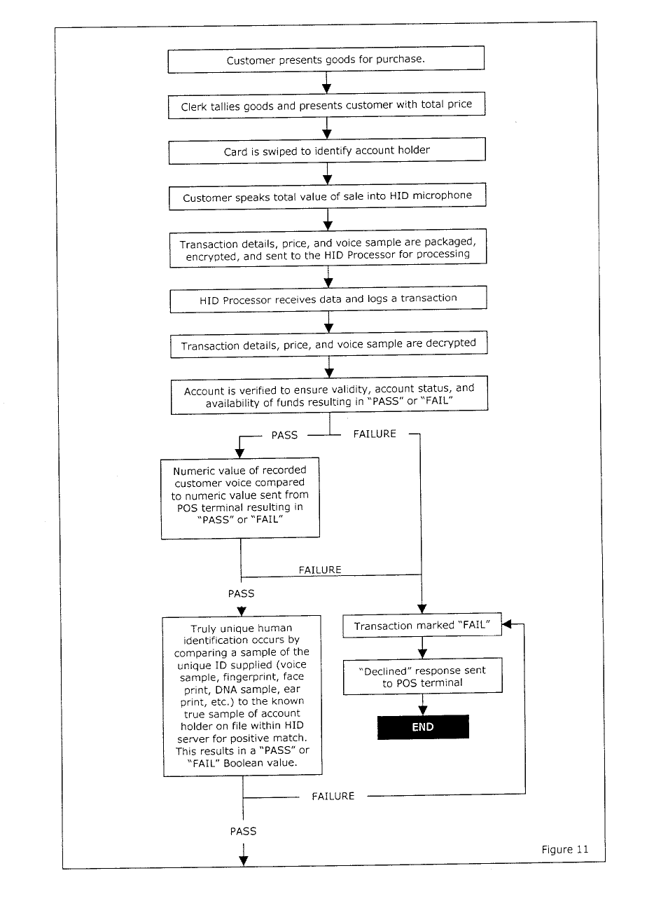

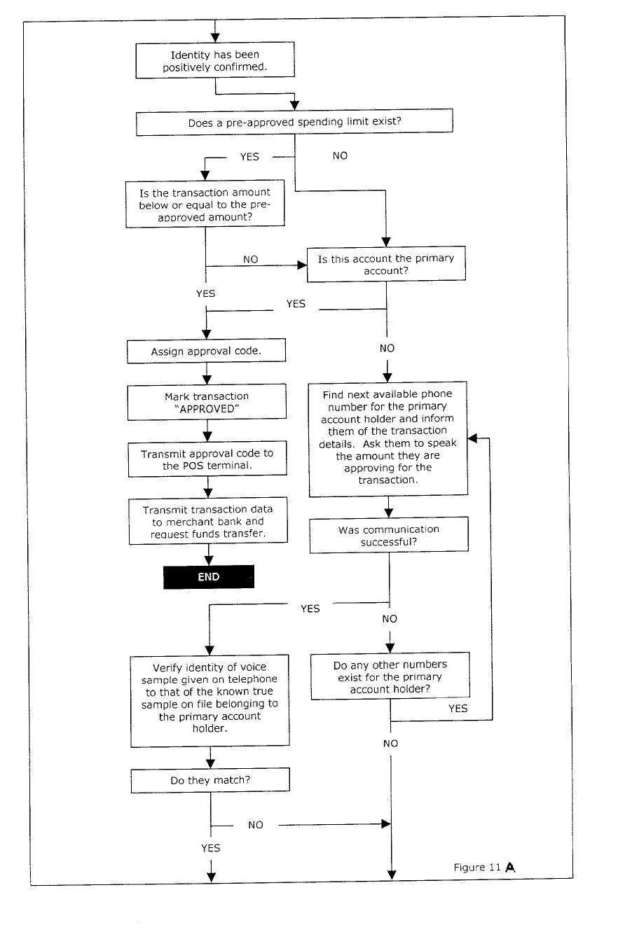

Referring now to FIG. 10, which depicts a flow of activities required to implement a mbre secure method of authorizing credit card transactions.

Credit card companies issue a credit card, in the first instance, to an individual referred as the primary card holder. The primary card holder is typically the individual who is legally responsible for payments and the safety and security of said credit card. At the time of issuing said credit card to the primary card holder, or at any future time, the credit card company, will at the request of the primary card holder, issue cards to other named individuals, being known as secondary card holders. Said secondary card holders, in the current art, are authorized to execute transactions which will be reflected on the bill issued to the primary card holder. It can be seen that, as there are more cards issued, effectively in the name of the primary card holder, that the financial risk, due to loss of any card, theft of any card, or any other fraudulent use, is significantly increased.

Therefore the invention incorporates a method of increasing security, which involves the credit card company seeking the authorization of the primary card holder for transactions executed by any primary or secondary card holders.

The invention also promotes the allocation of a credit limit to each secondary card holder, which represents a portion of the credit available to the primary card holder. For example, if the primary card holder has a credit limit of 10,000 US dollars and there are four secondary card holders, then each secondary card holder could be restricted to a maximum balance of 1,000 US dollars. This means that the primary card holder could lock themselves to a limit of 6,000 US dollars, and if all card holders use their maximum allowance then the limit of 10,000 US dollars would be reached. At all times the primary card holder is in control over the portion of the credit limit allocated to each secondary card holder, and can increase or decrease it accordingly. Similarly, the primary card holder can temporarily suspend use of any secondary card.

At step 3100 any card holder, being primary or secondary, executes a transaction. The merchant will read the credit card details which will in turn be passed to the credit card company. At step 3110 the credit card company will see if the primary card holder has sufficient remaining credit to support the transaction. If not the transaction will automatically be declined by the credit card company shown by flow moving to step 3170.

At step 3130 the primary card holder is contacted for additional authorization which can be provided by the primary card holder entering a pin number on a telephone, using DTMF, or by means of voice communication. However, the invention promotes the use of phone 3040 (see FIG. 9) at step 3130 by sending a message to the phone of the primary card holder. The primary card holder then replies to the message indicating whether the transaction is authorized at step 3150 or declined when flow moves to step 3170. In either instance flow ends at step 3160.

The invention also facilitates rules that can be contained within the preferred communication device (PCD) used by the primary card holder, one such device is phone 3040, which can be used by the primary card holder to automatically govern the spending capabilities of all card holders.

Transaction limit is defined as the maximum amount of money that can be spent on a single transaction by a card holder. Said transaction limit can be set individually for each card, secondary or primary, by the primary card holder.

The PCD comprises basic computing capabilities, as is the case for any mobile telephone supporting WAP or GPRS capabilities, or most mobile phones known in the art. Similarly, PDA's and other pocket computing devices, coupled with a form of communication will also act as a PCD.

When the primary card holder is queried by the credit card company for their authorization of any transaction, the PCD can be set by the primary card holder to automatically provide an authorization response, if the card in use has sufficient credit limit, allocated from the total credit limit of the primary card holder. If the transaction would exceed the credit limit, allocated by the primary card holder, then the PCD automatically responds with a declined response.

The PCD will also examine said transaction limit allocated to each card, such that if the amount of spend for the transaction exceeds the related transaction limit then authorization will be declined by the PCD.

The role of the PCD is effectively to lighten the load on the primary card holder in automatically processing authorizations. The primary card holder is free at any time to say whether the PCD should act in this role or not. The primary card holder may only wish for the PCD to act in this role if they are not available in person to process transactions.

The invention has great strength when used in this manner, as not only proof of possession of a credit card is being sought, but also a response from a pre-agreed telephone number, used by the primary card holder is used. Therefore theft of a credit card in itself may not be enough to defraud the credit card company. An unauthorized transaction would also require use of the PCD, which is unlikely to be available to any unauthorized user. Additionally, the PIN CODE used by the primary card holder to authorize transactions must be known, making it increasingly unlikely that unauthorized users will be successful in defrauding credit card companies.

To accomplish this task, the invention uses a method and apparatus that is analogous to an asymmetrical cryptosystem. That is, their is a public key which corresponds to an apparatus, such as a credit card with a magnetic strip or a device such as the SPEEDPASS as marketed by the Mobil Oil Corporation. In fact, this part of the invention can be any structure having a variety of shapes as long as it is possible for identification member to have the ability to respond to an inquiry from the identification member's corresponding reader to supply the requested information. While this information is not supposed to be “public”, the fact remains that such information is not that difficult to obtain. For example, account numbers, social security numbers, addresses, mother's maiden name, and so on are readily available to virtual anyone having a minimum of knowledge and resources to obtain. Thus, as noted above, the ease by which stolen, skimmed or unauthorized cards is well known. Further, identity theft is also quite easy as there is currently no universal, readily available method that prevents a thief from taking the “public” information to set up new accounts without the knowledge of the actual party. Even four or six digit pin numbers have been compromised by having a thief watch the person entering the number.

The reader that obtains the information from the user's identification member can be located at the point of purchase or remote from it. In fact, the reader can be placed on the user's cellular telephone so that the user can automatically transmit his “public” identification data such as account number, expiration date, credit card issuer, etc. via the user's cell phone. The reader could also be used as means for charging tolls charges, state park entry fees, parking fees, etc. using the SPEEDPASS technology which doesn't require a physical connection between the identification member and the reader.

In light of this, the identification member should not have account numbers embossed on the structure as is now done with typical credit cards. Nor should a signature line be present because as is noted below, a person's signature as it is currently being used does little to prevent fraud due to the fact that the authenticity of the signature is determined by a store clerk or in the case of purchases via the telephone or on-line unless a digital signature is used as noted above. In fact, the signature on the card may yield a false sense of security.

The next step is to provide a “private key” that is analogous to the private key in an asymmetrical cryptosystem. However, rather than using a variation of a password, the “private key” should be selected that corresponds uniquely to the credit card holder. There are a number of such indicia found with human beings that meet this objective criteria such as fingerprint's, retina configuration, voice sound, writing sample (signature but not as used currently), ear shapes, face, DNA code, to name just a few. Any of these indicia can be used to positively identify a person as being the authorized person in whom the account was set up. In fact, if a data base existed that stored one or more of these unique indicia as belonging to a particular named person with a corresponding public key such as a social security number, it would be virtually impossible for a thief to successfully steal the identity of someone. Further, this method and apparatus can successfully be part and parcel of the national identification system that substantially reduces the number of illegal aliens in the United States. This is a problem that has overshadowed most others since Sep. 11, 2001.

The essence of the invention is to utilize the private key in combination with the public key to provide substantially a perfect match. In so doing, the incidence of fraud, claims of repudiation of the contract, chargebacks, and cases of fraud due to mistaken identity will all be reduced to virtually zero.

The essence of the invention is the system by which one of these unique human identifiers can be simply and reliably used to ensure for a valid confirmation that the credit card is being used by the true owner. The reader that provides the public information can also be used to provide the private key to the credit card issuer or service organization wherein the invention then issues an authorization to the merchant or other entity requesting such confirmation of the user's identity. More important, losses to merchants, card issuers, insurance companies and, most importantly, the general public have been, for all intents and purposes, eliminated.

Essentially, the public information is used the same as found with current practice. The account number is confirmed, the amount requested is confirmed to be less than the daily or total limits, and the merchant enters his code, and so on. However, before an authorization is obtained, the reader must transmit the user's unique private key. This information is then compared to a known valid sample residing on the card issuer or service organization's data base and compared for accuracy. A match must be obtained before an authorization will be issued.

Referring to FIG. 10, a typical transaction involving an account holder 10100 at the merchant's point of sale is described in detail. As noted above, the method and apparatus can also be used over the internet or via telephone where the account holder and the merchant are separated by substantial distances. Account holder 10-100 presents the merchant with the goods/services that he/she wishes to purchase. Merchant 10-110 then receives this request from account holder 10-100 and informs account holder 100 of the price of the transaction. Merchant 10-110 when tallies the purchase order with the point of sale (POS) terminal 10-120. POS terminal 10-120 then transmits the details of this transaction to terminal 10-150 which the inventor has identified by the trademark “huMAN-ID” brand of terminal. In the situation where internet purchases are being made, there is no POS terminal 10-120 and the web server will fulfill the role of the POS server.

Account holder 10-100 also swipes his/her credit card through reader 10-130. Card reader 10-130 reads the account number from the magnetic strip on the back of the card. Then card reader 10-130 transmits this account number to terminal 10-150 as well. This system will work with standard credit card having a magnetic stripe on the back. This type of card is typically 3½ inches by 2 inches having a magstripe on the back. Track 1 of the magstripe is capable of having 210 bits per inch (BPI) of information stored thereon and can contain 76 6-bit plus parity bit read only characters. Track 2 is capable of storing 75 BPI and can hold 40 4-bit plus parity bit characters. Track 4 is another 210 BPI but is configured to hold 107 4-bit plus parity bit characters. All three tracks have the account number of the user's card encoded thereon in the format corresponding to the particular track number. The card reader is attached to terminal 10-150 via either USB or serial connection depending on the particular brand selected. Other methods of connection could also be used including wireless.

Identity reader 10-140 is used to record the credit card holder's voice. Once the user learns the price of the transaction, the card holder speaks the dollar amount into the microphone in the following manner. The price is read from left to right. As example, assume a product that cost $12,245.78. The user would say “twelve thousand, two hundred, forty-five dollars and seventy-eight cents.” Note that the greater the number of numbers that are used to obtain the authentication, the greater the accuracy. Since more digits correspond to larger purchases and/or greater credit lines, this is consistent with the need for greater authentication accuracy.

During the enrollment process discussed below, it is anticipated that for most credit line amounts, a 46 word number vocabulary will be sufficient to provide for authentication accuracy that eliminates the probability of false positives. For example, one, two, three, etc., twenty, thirty, forty, etc., one hundred, two hundred, three hundred, one thousand, two thousand, three, thousand, etc. ten thousand, twenty thousand, thirty thousand, etc. This provides the 46 word vocabulary which is used to compare the spoken purchase price for the purposed of comparison.

False negatives, that is, an actual failure of the legitimate card holder to have his/her to have his transaction authenticated can be handled in a variety of ways. The simplest is to provide a second identifying means such as a pin number, photograph, a phone number that can provide approval and so on.

The ability to use languages other than English for the numerical values will require additional processing algorithms and software to be created and running

Identity reader 10-140 transmits the audio signal received from the microphone to terminal 10-150. The microphone is preferably a low power unidirectional condenser model, well known in the art. The frequency range preferably should extend from 20 to 20,000 Hz to insure that the user's voice is reproduced accurately. A windscreen should be included with the microphone to prevent “pops”, “hisses” so that the signal to noise ratio is sufficient to prevent as many false negatives as practical.

Terminal 10-150 is preferably a standard Pentium-based computer running either Windows 2000 or Windows XP. Obviously, as technology changes, other computers and/or operating systems may be preferable in the future. The microphone that is used to record card holder's voice is connected to the audio port of the computer's sound card. Terminal 10-150 is connected to the point of sale terminal 10-120 via any connection method well known in the art such as USB, infrared, Ethernet, etc. depending on the configuration of terminal 10-120.

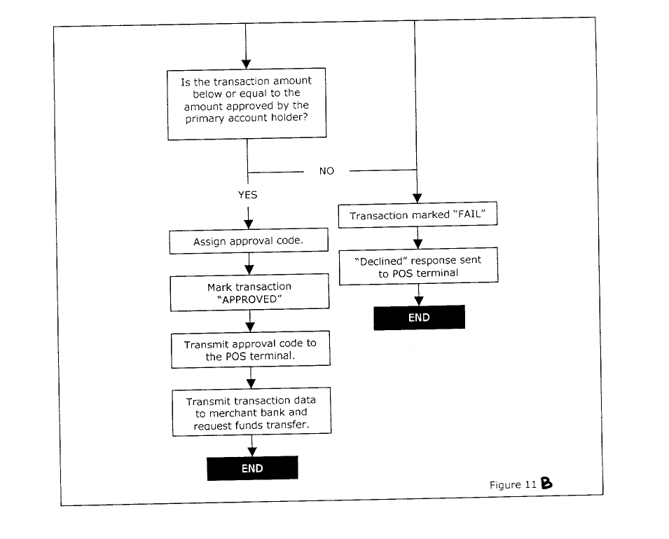

In operation as described in FIG. 11, terminal 10-150 receives the account holder's account number from credit card via card reader 10-130. Terminal 10-150 receives the card holder's voice from identity reader 10-140 and records the audio file onto terminal 10-150's hard drive. The audio file and the text-based transaction data is compressed into a single file using an encryption algorithm such as BLOWFISH, NEW DES, etc and sent to Server 160 via TCP/IP using the internet. This file also includes a request to server 11-160 to determine whether transaction is approved.

Server 11-160 is also preferably a standard Pentium-based computer running either Windows 2000 or Windows XP. As noted above, as technology changes, other computers and/or operating systems may be preferable in the future. Upon receipt of the encrypted file, terminal 11-160 decrypts and unpacks the file restoring it to its original form. Terminal 11-160 also creates a new transaction entry within its database having a “pending” status. Server 11-160 verifies the identity of the account holder as described in FIG. 11 by initiating a verification process. If the card holder's voice is used to authenticate the identity of the account holder, then the recording of the card holder's voice reciting the price is compared against a standard that was obtained from the card holder during the enrollment process using software such DRAGON DICTATE as manufactured by Lernout & Hauspie Speech Products N.V., Inc., 52 Third Avenue, Burlington, Mass. 01803, now owned by ScanSoft, Inc. of 9 Centennial Drive, Peabody, Mass. 01960. However, other software that accomplishes the task of comparison of one sound file to another to provide a probability that both files were created with the same voice could also be used.

If finger prints are used to authentic the card hold's identity, the process would be essentially the same, except that the comparison would be made using software used to compare finger prints. This type of software is also well known in the art. If face recognition were used to authenticate, the card holder's face would be compared to a digital representation of the card holder's face that was provided during enrollment. Similarly, any unique aspect of a card holder that can be used to authenticate that the person conducting the transaction is actually the card holder can be used as part of the invention. Some unique criteria will be easier to utilize than others and some will provide different levels of security. The criteria to be used and the probability of authenticating will be depend on the card holder's credit line and transaction amount. Clearly, a credit line of $500 with a purchase of $50 does not require the same level of protection as does a credit line of one million dollars with a purchase of $50,000.

Irrespective of the level or criteria that are used, it is expected that the comparison step should have a default confidence level of at least 85% but the actual value should be determined in conjunction with the merchant and/or lending authority and, perhaps, the card holder. If the match meets or exceeds the confidence level, then an APPROVED signal is sent, otherwise a DENIED will be issued. Assuming this level of accuracy, the invention will same hundreds of millions of dollars each in reduction of fraud to say nothing in the indirect cost of trying to restore a card holder's credit and replacement of new cards, etc.

Once the authenticating process is complete, the server 160 logs the status of the transaction that is approved or denied within its database. In the situation of a merchant-sponsored credit card such as a gasoline credit card, server 160 interacts with the private billing or accounting servers and databases 170 belonging to the merchant for account-level verification.

Once the transaction has been approved, server 160 sends via gateway 180, notification of the merchant service provider with instructions to transfer funds from the account holder's account to the merchant's account. In this manner, there are no chargebacks to the merchant or long waits to be paid.

Another embodiment of the invention is the use a paper card with a magnetic strip, designed for one use only, but also serving as a receipt for any purchase made by the purchaser. The card's magnetic stripe will have all the information needed by the credit issuing institution such the store name, department, item(s) purchased, total amount, and limited information about the purchaser, but nothing that would enable an unauthorized party who happen to steal the card could benefit from.

Most of the information will already be encoded on the card, only the amount, items, and information about the purchaser needs to be added. It is envisioned that merchants would have a supply of these one time card, however, a user could also bring his/her own cards. This could be pre-encoded with the name and address of the user as well as the telephone number that must be dialed to initiate the authorization procedure.

Each card would also have a place for the purchaser's signature. The card once signed and the transaction has been authorized can be kept by the merchant with a copy provided to the purchaser to serve as a receipt. Note that even after going through the authenticating process, there still be no critical information on the card such as the purchaser's account number, PIN number, social security number, etc.

Once an activate account having sufficient credit line to make the purchase is verified, the next step is to authenticate that the person making the purchase is in fact authorized to do so. This can be accomplished using the methods noted above.

For example, to authenticate that the person is authorized to make the purchase, the signature of the purchaser can be compared to a stored signature residing in memory in the credit card issuer's server which will compare one against the other. If the signatures are considered to match, then credit card issuer which release the funds to merchant, either directly if the issuer is a bank or notify a bank to debit that purchaser's credit line and pay the merchant.

If this card is used in purchaser's swipe phone as described above, then other security measure become possible such as the use of typed in PIN which is then compared to the GUID of the SIM card.

The signature of the purported purchaser, the amount of the transaction, the merchant's information, can then be transferred electronically to the bank for another authentication procedure to verify that the purchaser's signature residing on the bank's computer again matches. If everything matches, then the banks computer releases the funds directly to the merchant and debits the purchaser's account.

It is important to note that there is nothing for a thief to steal in this process. The purchaser's disposable credit card need having nothing more imprinted on it except advertising material and telephone number which the merchant is to use to obtain authorization. If the purchaser's swipe phone is used, then clerk is unable to gain access to the purchaser's PIN. Even if the purchaser's swipe phone is stolen, the user can easily and instantly lock the system down by merely accessing the server on another phone and using a preset code, a super PIN, to stop all incoming and outgoing calls from that phone.

The one time use cards are useless unless an authorization has been provided by the credit card issuer.

Even if the signed card was stolen so that a thief could practice the purchaser's signature, if the swipe phone is used to transmit the information to the credit card issuer, then the thief will also have steal the swipe phone and somehow learn the PIN as well and make certain that the authorized user is unaware that the phone has been stolen. The likelihood of this happening is extremely remote and makes fraud virtually impossible.

To prevent the signature from being copied, the one time use cards can be provided with a signature surface similar to that found on credit card so that purchaser's signature can be etched on the card for transmission but then surface can be removed afterwards making it impossible to see the purchaser's signature.

Still another embodiment of the credit card authorization method is to utilize an imaging processing technique when the purchaser is present at the point of sale. This embodiment eliminates the need for an actual credit card. Instead, the purchaser utilizes a “virtual” credit card which is in essence the likeness of the purchaser him/herself.

This method could also be used on line if a video camera were attached to the person's personal computer.

As noted above, the purchaser would preferably use his phone as shown in FIG. 9 to contact his credit card company or bank. The merchant would then provide his identification number which would include a number to dial as well as the sale information such purchase amount, item, department, other such information. This information can be provided to the purchaser by a magnetically encoded card such as presently being used for parking garages and the District of Columbia Transit System farecard and as described in previous embodiment.

This card will also function as a receipt for the purchaser. The card can be swiped by the user's phone so that the information does not have to reentered into the phone but is provided by the card/receipt provided by the merchant. Once the server identifies the account, verifies that purchaser's account is active and the amount is within the limit, the stored image of the purchaser is sent to the merchant's screen.

The amount of storage required to provide a head shot of the purchaser is only about 20 kb assuming that a JPEG file is used. While this resolution requires high compression and is considered low quality, this will provide 720 by 480 pixels which is current television resolution. Further, the picture will be better than currently provided by typical photographic identification such a license pictures, etc.

Current hard drive technology is such that a 120 gigabyte hard drive, as made by Western Digital, sells for about $150. A plain vanilla server is able to handle several such drives. Each drive would store about 6 million photographs per hard drive. Further, access time is virtually instant. Even a typical PDA could store more than one thousand of such photographs. Thus, the hardware and cost to do this is well within the limits of current technology and can be accomplished by those having ordinary skill in the art.

Since this technology is so relatively inexpensive and yet robust, it is entirely possible for a business establishment to have photographs of each customer and spouse and children and other authorized individuals who are permitted to charge on that account. Then, the merchant would only to have send the likeness of the individuals not on their database sent for verification.

By having a video camera available at the point of sale, a new photograph could be uploaded to the purchaser's server each time a purchaser is made. Thus, the likeness of the purchaser would always remain current despite changing hairlines, hair color, aging, scars, etc.

Rather than having the merchant's clerk made the comparison of the likeness of the purchaser to that of the digital image, it is also possible using technology well known in the art to use the computer to make this comparison. Face recognition using a very few criteria has been known for some time. Even before the advent of computers, it was recognized that it was possible to distinguish an individual from all others in a population of more than six million by merely making 14 simple measurements such as distance between the pupils, distance between the ears, etc. By adding software that automatically make such calculations using the digital image and then comparing those dimensions taken from the purchaser, the computer can easily authenticate whether that person is in fact the authorized person.

It is also possible to use this well known technology to provide a method for a purchaser who was being forced to make a purchase or withdraw funds from the purchaser's account by using a cue that was easily detectable by the computer but the party forcing the purchaser to conduct the transaction would not be aware that such a signal was being provided. For example, the cue might be something as simple as tightening a muscle on one side of the face but not the other. In this manner, the computer would “recognize” that something was wrong and immediately notify the proper authorities such as the local police department or the store detectives.

The illustrated embodiments of the invention are intended to be illustrative only, recognizing that persons having ordinary skill in the art may construct different forms of the invention that fully fall within the scope of the subject matter appearing in the following claims.

What is claimed is:

1. A telephony system comprising:
at least one handset having a unique contactable telephone number;
a computer server in communication with said at least one handset; and
memory means, provided in said server, for storing a plurality of distinct selectable telephone numbers such that a user is able to select at least one of said plurality of distinct selectable telephone numbers wherein said server will then associate said selected at least one distinct selectable telephone numbers with said unique contactable telephone number such that a party dialing said selected at least one distinct selectable telephone numbers will reach said user's at least one handset.

2. The telephony system of claim 1 wherein said at least one handset is provided with a magnetic card swipe port.

3. The telephony system of claim 1 wherein said at least one handset is provided with a smart chip reader.

4. The telephony system of claim 1 further comprising:
means for changing said user's mode of operating wherein said user can change how calls are handled by said server by having said server having at least one mode selected from a group of modes consisting of forward a call, storing the caller's telephone number, denying access to a particular caller, requesting the intended call forwarded number when the forwarding feature will be accepted, and leave an informational message for a particular user.

5. The telephony system of claim 1 wherein the magentic swipe apparatus on said at least one handset is used to transmit credit card authorization information to a credit card issuer.

6. The telephony system of claim 5 wherein said credit card authorization information transmitted to said credit card issuer is at least one data criteria selected from the group of criteria consisting of facial recognition data, fingerprint data, signature data, password entry data, and voice recognition data.

7. A method of purchasing merchandize and services on credit using a one time use credit card having a magnetic strip that has no preprinted and no encoded information on said card that provides a thief with the ability to learn a user's account number.

8. The method of claim 7 wherein an authorization is provided by the user's sliding said one time use credit card that has had the magnetic strip encoded with purchasing amount, merchant identification, information concerning the purchase, name and address of the user, through user's swipe phone such the information encoded on the magnetic strip along is transmitted along with unique data that can be provided only by the user is sent to user's credit card issuer to verify that the party transmitting the information and unique data is, in fact, the authorized user.

9. The method of 8 wherein the unique data is a digital image of the user's face.

10. The method of claim 8 wherein the unique data is digital image of the user's signature.
